(19) United States
(12) Patent Application Publication
(10) Pub. No.: US 2024/0422231 A1
(43) Pub. Date: Dec. 19, 2024

(54) INFORMATION PROCESSING APPARATUS, INFORMATION PROCESSING METHOD, AND STORAGE MEDIUM

(71) Applicant: NEC Corporation, Tokyo (JP)

(72) Inventors: Kazufumi KOJIMA, Tokyo (JP); Masahiro TANI, Tokyo (JP); Keisuke IKEDA, Tokyo (JP)

(73) Assignee: NEC Corporation, Tokyo (JP)

(21) Appl. No.: 18/732,769

(22) Filed: Jun. 4, 2024

(30) Foreign Application Priority Data
Jun. 14, 2023 (JP) 2023-097564

(51) Int. Cl. H04L 67/306; G06Q 50/00

(52) U.S. Cl. CPC H04L 67/306; G06Q 50/01

(57) ABSTRACT

To accurately decide identity of a person using a plurality of target accounts, an information processing apparatus includes a determination unit and a decision unit. The determination unit determines a first acquaintance account group and a second acquaintance account group being associated with a first target account and a second target account, respectively. The decision unit decides identity of a person using the first target account and the second target account, based on similarity between a first person group and a second person group using the first acquaintance account group and the second acquaintance account group, respectively.

### TECHNICAL FIELD

The present invention relates to an information processing apparatus, an information processing method, and a storage medium.

### BACKGROUND ART

Various social networking services (SNSs) are commonly and widely used, and the same person may use a plurality of accounts. When information provided by an SNS (SNS information) is utilized for various purposes such as marketing and background check for a job seeker or a prospective student, and the like, it is advantageous to be able to distinguish identity of a person using a plurality of accounts.

For example, International Patent Publication No. WO2021/260840 discloses a reliability analysis system that decides whether a plurality of accounts are derived from the same person by weighting a similarity degree derived from an account and a similarity degree derived from a friend account derived from the account with reliability degrees of the accounts and computing a similarity degree therebetween.

In the reliability analysis system described in International Patent Publication No. WO2021/260840, the similarity degree derived from the friend account is a similarity degree of a subject image acquired by acquiring a posted image of the friend account, based on a friend list of each of an account A and an account B, and extracting from the acquired posted image. Further, the similarity degree derived from the account is a similarity degree of a subject image extracted from a posted image of each of the account A and the account B. In the reliability analysis system described in International Patent Publication No. WO2021/260840, when the reliability degrees of the account A and the account B are low, the similarity degree derived from the friend account is given priority.

### SUMMARY

In general, with regard to friend accounts that are included in friend lists of the account A and the account B, even when the friend accounts are used by the same person, the person posts different post images with each of the friend accounts in some cases. In such a case or the like, a similarity degree derived from the friend account, which is described in International Patent Publication No. WO2021/260840, may not be a value appropriately representing whether the account A and the account B are derived from the same person.

In view of the above-mentioned problem, one example of an object of the present invention is to provide an information processing apparatus, an information processing method, a program, and the like that are capable of accurately deciding identity of a person using a plurality of target accounts.

According to one aspect of the present invention, there is provided an information processing apparatus, including:
a determination unit that determines a first acquaintance account group and a second acquaintance account group being associated with a first target account and a second target account, respectively; and
a decision unit that decides identity of a person using the first target account and the second target account, based on similarity between a first person group and a second person group using the first acquaintance account group and the second acquaintance account group, respectively.

According to one aspect of the present invention, there is provided an information processing method, including,
by one or more computers:
determining a first acquaintance account group and a second acquaintance account group being associated with a first target account and a second target account, respectively; and
deciding identity of a person using the first target account and the second target account, based on similarity between a first person group and a second person group using the first acquaintance account group and the second acquaintance account group, respectively.

According to one aspect of the present invention, there is provided a program for causing one or more computers to execute:
determining a first acquaintance account group and a second acquaintance account group being associated with a first target account and a second target account, respectively; and
deciding identity of a person using the first target account and the second target account, based on similarity between a first person group and a second person group using the first acquaintance account group and the second acquaintance account group, respectively.

According to one aspect of the present invention, it is possible to accurately decide identity of a person using a plurality of target accounts.

### BRIEF DESCRIPTION OF THE DRAWINGS

FIG. 1 is a diagram illustrating an overview of an information processing apparatus.

FIG. 2 is a flowchart illustrating an overview of information processing.

FIG. 3 is a diagram illustrating one example of a configuration of an information processing system.

FIG. 4 is a diagram illustrating one example of a functional configuration of the information processing apparatus.

FIG. 5 is a diagram illustrating a functional configuration example of a decision unit.

FIG. 6 is a diagram illustrating a physical configuration example of the information processing apparatus.

FIG. 7 is a flowchart illustrating one example of information processing.

FIG. 8 is a flowchart illustrating one example of decision processing.

FIG. 9 is a diagram illustrating one example of first likelihood.

FIG. 10 is a diagram illustrating a functional configuration example of a determination unit.

FIG. 11 is a flowchart illustrating another example of determination processing.

FIG. 12A and FIG. 12B are a diagram illustrating one example of second likelihood.

FIG. 13 is a diagram illustrating another example of the first likelihood.

FIG. 14A and FIG. 14B are a diagram illustrating another example of the second likelihood.

FIG. 15A and FIG. 15B are a diagram illustrating further another example of the first likelihood.

### EXAMPLE EMBODIMENT

Example embodiments of the present invention are described below with reference to the drawings. Note that, in all the drawings, a similar constituent element is denoted with a similar reference sign, and description therefor is omitted as appropriate.

### Overview of Example Embodiment

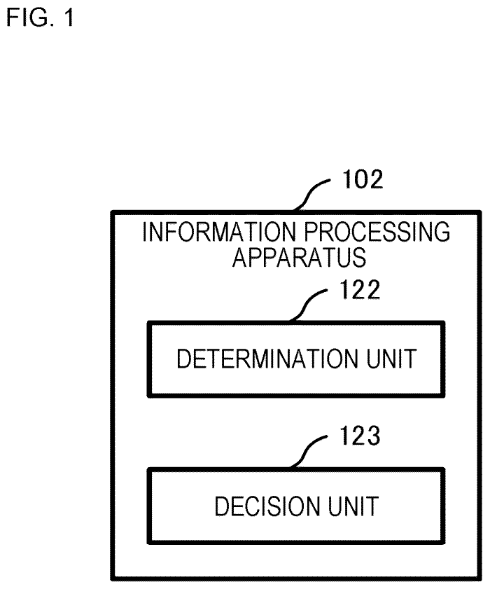

FIG. 1 is a diagram illustrating an overview of an information processing apparatus 102. The information processing apparatus 102 includes a determination unit 122 and a decision unit 123.

The determination unit 122 determines a first acquaintance account group and a second acquaintance account group that are associated with a first target account and a second target account, respectively, the decision unit 123 decides identity of a person using the first target account and the second target account, based on similarity between a first person group and a second person group that use the first acquaintance account group and the second acquaintance account group, respectively.

According to the information processing apparatus 102, it is possible to accurately decide identity of a person using a plurality of target accounts.

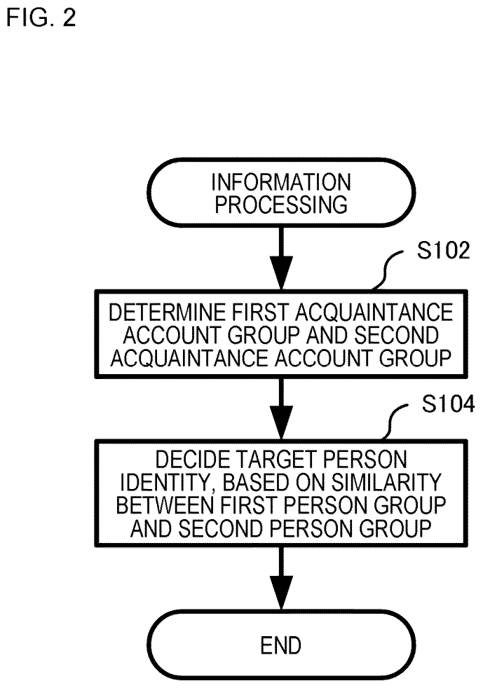

FIG. 2 is a flowchart illustrating an overview of information processing.

The determination unit 122 determines the first acquaintance account group and the second acquaintance account group that are associated with the first target account and the second target account, respectively (step S102). The decision unit 123 decides the identity of a person using the first target account and the second target account, based on the similarity between the first person group and the second person group that use the first acquaintance account group and the second acquaintance account group, respectively (step S104).

According to the information processing, it is possible to accurately decide identity of a person using a plurality of target accounts.

### First Example Embodiment

### (Configuration Example of Information Processing System 100)

An information processing system 100 is a system for deciding identity of a person using a plurality of target accounts. The information processing system 100 includes one or a plurality of social networking service (SNS) management apparatuses 101 and an information processing apparatus 102.

Each of the one or plurality of SNS management apparatuses 101 is an apparatus for providing an SNS, and manages SNS information, for example. The information processing apparatus 102 is an apparatus for deciding identity (hereinafter, also referred to as “target person identity”) of a person using a plurality of target accounts. The information processing apparatus 102 decides the target person identity by using an associated account group being associated each of a first target account and a second target account. For example, the information processing apparatus 102 decides the target person identity by using the SNS information relating to the associated account group.

The one or plurality of SNS management apparatuses 101 and the information processing apparatus 102 are connected to each other in such a way as to be capable of transmitting and receiving information mutually via a network NT. For example, the network NT is a communication circuit configured by a wired type, a wireless type, or a combination thereof.

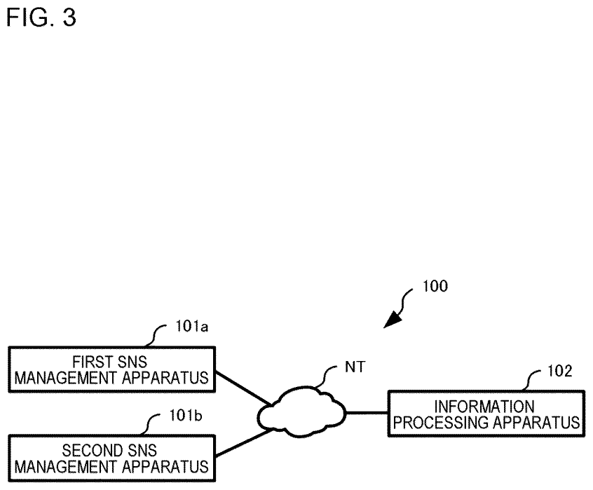

FIG. 3 is a diagram illustrating one example of a configuration of the information processing system 100. Each of a first SNS management apparatus 101a and a second SNS management apparatus 101b illustrated in the drawing is an example of the SNS management apparatus 101. In other words, in the drawing, an example in which the information processing system 100 includes the two SNS management apparatuses 101 is illustrated. Note that, as described above, the information processing system 100 is only required to include the one or plurality of SNS management apparatuses 101, the number of SNS management apparatuses 101 included in the information processing system 100 is not limited to two.

### (With Regard to SNS Information)

The SNS information is information used for providing an SNS, and is managed by each of the one or plurality of SNS management apparatuses 101. For example, the first SNS management apparatus 101a manages first SNS information being SNS information for providing a first SNS. For example, the second SNS management apparatus 101 manages second SNS information being SNS information for providing a second SNS. The first SNS and the second SNS are SNSs different from each other.

For example, the SNS information includes one or more of (1) a user identification (ID), (2) profile information, (3) account association information, (4) information relating to another SNS account, (5) post information, (6) transmission/reception information, and the like for each account. For example, in the SNS information, the user ID is associated with another piece of information.

The account is an account registered in an SNS, and the same applies to the following description.

(1) The user ID is information for discriminating each account on an SNS. For example, the user ID is automatically provided when a person using a SNS registers as a user on the SNS. For example, a user may not be allowed to change the user ID.

(2) The profile information is information relating to a user, and is registered by the user. For example, the profile information may include one or more of a display name, a date of birth, an address, a school the user graduated from, a contact destination (a phone number, an e-mail address, and the like), and an optional comment provided for self-introduction or the like, and the like.

For example, the display name is a name to be used by a user to indicate who the user is for another user or the like.

Specifically, for example, the display name is a name being optionally set by a user. The display name may be a name that does not overlap among a plurality of users using an SNS (in other words, a name that enables discrimination of each of the users on the SNS), or may be a name that allows overlapping among a plurality of users. Examples of the display name that allows overlapping among a plurality of users include a real name, a name other than a real name, and the like of a user. The real name may be any of only a family name, only a first name, and a family name and a first name.

(3) The account association information (hereinafter, also simply referred to as “association information”) is information for associating an account, which is discriminated by using the user ID associated with the association information, with another account being used on the same SNS.

For example, the association information includes information (information relating to another account) for determining the another account. With this, an account being discriminated by using the user ID associated with the association information and another account being determined by using the information relating to the another account, which is included in the association information, can be associated with each other. Note that, a method of associating another account is not limited thereto.

The account to be associated based on the association information may be set according to a management policy of an SNS, and is an account that a user permits to be associated or the like, for example. Typical examples of such an account can include accounts used by an acquaintance, a friend, a relative (a parent, a sibling, a child, and the like), a family member, a spouse, a romantic partner, a colleague, and the like.

The association information may further include relationship information. The relationship information is information indicating a relationship between a user and a person using another account, such as an acquaintance, a friend, a relative (a parent, a sibling, a child, and the like), a family member, a spouse, a romantic partner, a colleague, and the like, as described above.

(4) The information relating to another SNS account is information for determining an account used by a user on another SNS. For example, the information relating to another SNS account includes link information to another SNS and an account used by a user on the another SNS.

(5) The post information is information posted by a user on an SNS. For example, the post information may include one or more of a sentence, an image, and the like.

(6) The transmission/reception information is information being transmitted and received between an account being discriminated by using the user ID associated with the transmission/reception information and another account. The transmission/reception information includes one or more of information being transmitted from the account being discriminated by using the user ID to the another account, information being received by the account being discriminated by using the user ID from the another account, and the like.

For example, the transmission/reception information include one or more of a comment, a reply to a comment, a conversation, and the like. The comment is a sentence, an image, or the like being received from another account with respect to a post. The reply is a sentence, an image, or the like being transmitted with respect to the comment from the account being discriminated by using the user ID. The conversation is a sentence, an image, or the like being transmitted or received directly (for example, without referring to a post) between the account and the another account.

Note that, the information included in the SNS information is not limited to the examples given herein.

For example, the post information may further include position information indicating a location from which the post information is transmitted. For example, the transmission/reception information may include position information indicating a location from which the transmission/reception information is transmitted. Those pieces of position information may be acquired by using a global positioning system (GPS) function or the like being provided to a terminal transmitting the information, for example. For example, the transmission/reception information may include at least one of timing at which the transmission/reception information is transmitted, and timing at which the transmission/reception information is received. The timing may be indicated with a format of year/month/day, a time, and the like.

(With Regard to Term Associated with Account)

(1) A plurality of target accounts, (2) an associated account group, and (3) an acquaintance account group, which are terms used in association with an account in the present disclosure, are described.

(1) The plurality of target accounts are accounts being targets for which identity of a person using those accounts is decided. For example, the plurality of target accounts may be accounts that are appropriately selected as targets for deciding the target person identity.

The plurality of target accounts may include a first target account and a second target account. For example, the first target account and the second target account may be target accounts that are optionally selected from the plurality of target accounts and are different from each other.

In the example embodiment, description is made on an example in which the first target account and the second target account are accounts used on SNSs provided by the first SNS management apparatus 101a and the second SNS management apparatus 101b, respectively. Specifically, for example, the first target account and the second target account are accounts that are selected as targets for deciding the target person identity from the accounts used on the first SNS and the second SNS.

Note that, the plurality of target accounts may include a plurality of accounts that are selected from accounts used on an SNS provided by one SNS management apparatus 101. In this case, the first target account and the second target account may be accounts used on the SNS provided by the one SNS management apparatus 101.

(2) The associated account group consists of one or a plurality of associated accounts. The associated account is an account being associated with the target account. For example, the associated account is another or a plurality of other accounts being associated based on the association information relating to the target account. Specifically, for example, the associated account is another or a plurality of other accounts being associated based on the association information associated with a user ID in the SNS information including the user ID associated with the target account.

(3) The acquaintance account group consists of one or a plurality of acquaintance accounts. The acquaintance account is one or a plurality of accounts, which are used by a person in a predetermined relationship with a person using the target account, among the associated accounts. The predetermined relationship indicates a relationship close enough, for example, a relationship being transmitted/received information. For example, the acquaintance account group in this case may be determined by using the transmission/reception information including in the SNS information relating to at least one of the target account and the associated account group.

Specifically, for example, the acquaintance account group may be determined when a condition is satisfied, the condition where the transmission/reception information includes at least one conversation, mutual conversations, and the like between the target account and the associated account. In this case, when at least one of a condition where the transmission/reception information relating to the associated account includes a conversation with the target account and a condition where the transmission/reception information relating to the target account includes a conversation with the associated account is satisfied, the associated account may be determined as the acquaintance account.

Note that, the predetermined relationship is not limited thereto, and may be changed as appropriate. For example, the acquaintance account may be determined by using at least one of a comment, a reply to a comment, and the like included in the transmission/reception information, together with a conversation or in place of a conversation.

### (Example of Functional Configuration of Information Processing Apparatus 102)

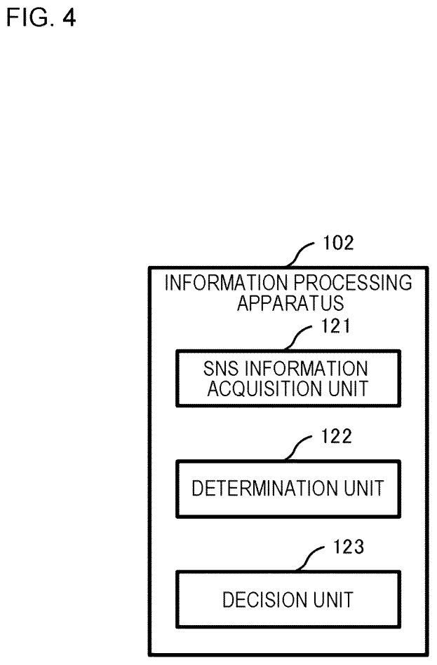

FIG. 4 is a diagram illustrating one example of a functional configuration of the information processing apparatus 102. For example, the information processing apparatus 102 functionally includes an SNS information acquisition unit 121, a determination unit 122, and a decision unit 123.

The SNS information acquisition unit 121 acquires SNS information relating to a plurality of target accounts and an acquaintance account group being determined by the determination unit 122 for each of the plurality of target accounts.

For example, the SNS information acquisition unit 121 acquires, from the first SNS management apparatus 101a, the SNS information relating to a first target account and a first acquaintance account group being determined for the first target account. The SNS information acquisition unit 121 acquires, from the second SNS management apparatus 101b, the SNS information relating to a second target account and a second acquaintance account group being determined for the second target account.

The determination unit 122 determines the acquaintance account group being associated with each of the plurality of target accounts.

For example, the determination unit 122 determines the first acquaintance account group and the second acquaintance account group that are associated with the first target account and the second target account, respectively.

The decision unit 123 decides identity of a person using the plurality of target accounts, based on similarity of a person group using the acquaintance account group being determined by the determination unit 122 for each of the plurality of target accounts.

For example, the similarity of the person group is represented by using an acquaintance similarity degree being a value computed based on first likelihood. The first likelihood is a value indicating a likelihood that a person using an acquaintance account is identical. For example, the first likelihood may be computed by using the SNS information associated with the acquaintance account (for example, the SNS information associated with a user ID of the acquaintance account).

Specifically, for example, the decision unit 123 decides the identity of a person using the first target account and the second target account, based on the similarity between the first person group and the second person group. The first person group and the second person group are person groups that use the first acquaintance account group and the second acquaintance account group, respectively.

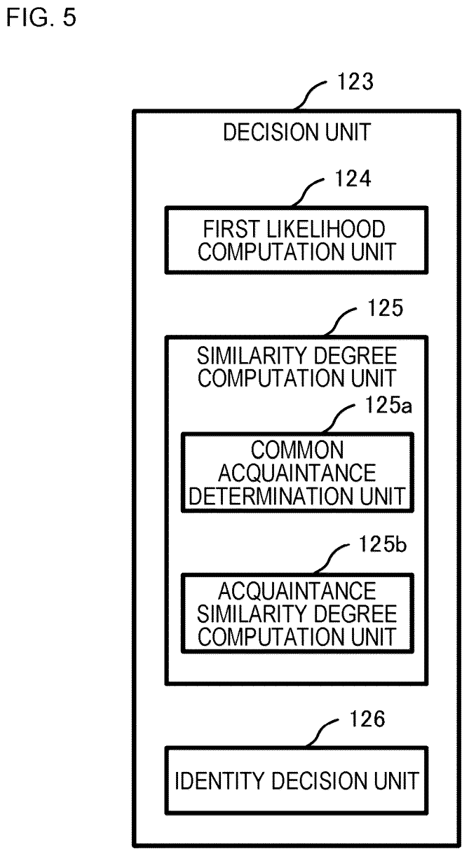

FIG. 5 is a diagram illustrating a functional configuration example of the decision unit 123. For example, the decision unit 123 functionally includes a first likelihood computation unit 124, a similarity degree computation unit 125, and an identity decision unit 126.

The first likelihood computation unit 124 computes the first likelihood for a combination of acquaintance accounts constituting the acquaintance account groups being determined for each of the different target accounts.

Specifically, for example, the first likelihood computation unit 124 computes the first likelihood for each combination of a first acquaintance account constituting the first acquaintance account group and a second acquaintance account constituting the second acquaintance account group.

The first likelihood is a value indicating likelihood that a person using the first acquaintance account and the second acquaintance account is identical. The first likelihood is computed based on the similarity of the SNS information associated with the first acquaintance account and the second acquaintance account.

The similarity degree computation unit 125 computes an acquaintance similarity degree indicating the similarity of the person group using the acquaintance account group being determined for each of the plurality of target accounts, by using the first likelihood being acquired by the first likelihood computation unit 124.

Specifically, for example, the similarity degree computation unit 125 computes the acquaintance similarity degree being a value indicating the similarity between the first person group and the second person group, by using the first likelihood being acquired by the first likelihood computation unit 124.

For example, the similarity degree computation unit 125 described above functionally includes a common acquaintance determination unit 125a and an acquaintance similarity degree computation unit 125b.

The common acquaintance determination unit 125a determines a common acquaintance account being a combination of the first acquaintance account and the second acquaintance account that are used by the same person, by using the first likelihood. For example, the common acquaintance account may be determined in such a way that both the first acquaintance account and the second acquaintance account are different from those of another common acquaintance account.

The acquaintance similarity degree computation unit 125b computes the acquaintance similarity degree by using the first likelihood being computed for the common acquaintance account being determined by the common acquaintance determination unit 125a.

The identity decision unit 126 decides the identity of a person using the plurality of target accounts, based on the acquaintance similarity degree being computed by the similarity degree computation unit 125. For example, the identity decision unit 126 decides the identity of the person using the first target account and the second target account, based on the acquaintance similarity degree being computed by the similarity degree computation unit 125.

### (Physical Configuration Example of Information Processing System 100)

The information processing system 100 is physically configured by the one or plurality of SNS management apparatuses 101 and the information processing apparatus 102 that are connected to each other via the network NT. Each of the one or plurality of SNS management apparatuses 101 and the information processing apparatus 102 is configured by single apparatus being different in a physical sense.

Each of the one or plurality of SNS management apparatuses 101 and the information processing apparatus 102 may be configured similarly in a physical sense. Herein, a physical configuration example is described while giving the information processing apparatus 102 as an example with reference to the drawing.

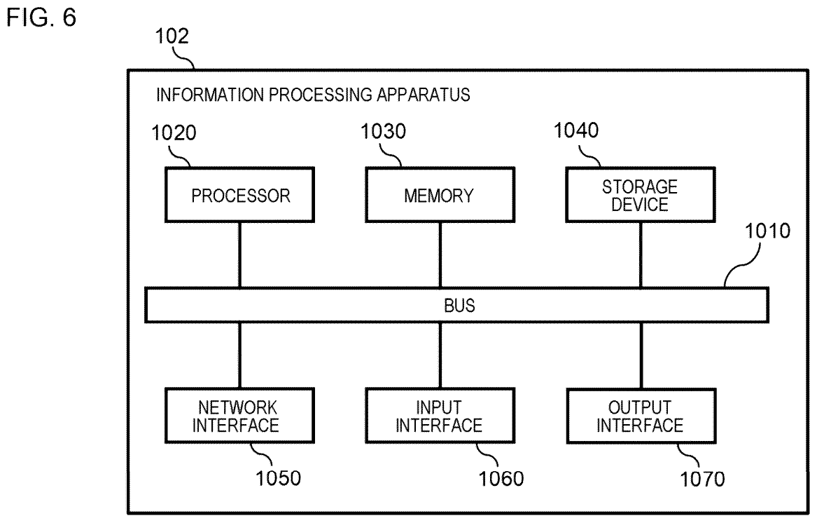

FIG. 6 is a diagram illustrating the physical configuration example of the information processing apparatus 102. For example, the information processing apparatus 102 physically includes a bus 1010, a processor 1020, a memory 1030, a storage device 1040, a network interface 1050, an input interface 1060, and an output interface 1070.

The bus 1010 is a data transmission path in which the processor 1020, the memory 1030, the storage device 1040, the network interface 1050, the input interface 1060, and the output interface 1070 transmit and receive data one another. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function of an apparatus provided therewith (for example, the information processing apparatus 102 in the example in FIG. 6). The processor 1020 reads each of the program modules on the memory 1030 and executes the program module, and thereby the function associated with the program modules is achieved.

The network interface 1050 is an interface for connecting the apparatus provided therewith (for example, the information processing apparatus 102 in the example in FIG. 6) to the network NT.

The input interface 1060 is an interface for inputting information by a user. For example, the input interface 1060 is configured by a touch panel, a keyboard, a mouse, or the like.

The output interface 1070 is an interface for providing information to a user. For example, the output interface 1070 is configured by a liquid crystal panel, an organic electro-luminescence (EL) panel, or the like.

Note that, the physical configuration of the information processing system 100 is not limited thereto. For example, the plurality of SNS management apparatuses 101 may be configured by a single apparatus, and the single apparatus may include the functions of the plurality of SNS management apparatuses 101. Further, the one or plurality of SNS management apparatuses 101 and the information processing apparatus 102 may be configured by a single apparatus, and the single apparatus may include the functions of the one or plurality of SNS management apparatuses 101 and the information processing apparatus 102. The plurality of SNS management apparatuses 101 herein may be a part or an entirety of the plurality of SNS management apparatuses 101 included in the information processing system 100. Further, for example, the single apparatus may be configured similarly to the information processing apparatus 102 illustrated in FIG. 6 in a physical sense.

### (Operation Example of Information Processing System 100)

Hereinafter, an operation of the information processing system 100 is described with reference to the drawings. For example, in the information processing system 100, the information processing apparatus 102 executes information processing. The information processing is processing for deciding the identity of a person using the plurality of target accounts.

For example, the information processing is started when specification of the plurality of target accounts is received. Note that, a trigger for starting the information processing is not limited thereto.

Hereinafter, description is made on the information processing by using an example in which identity of a person using the first target account and the second target account included in the plurality of target accounts being specified is decided.

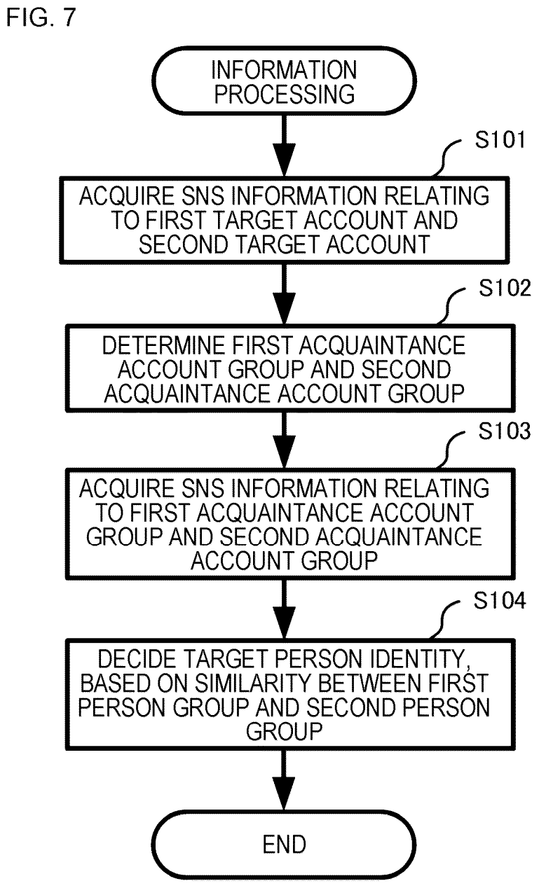

FIG. 7 is a flowchart illustrating one example of the information processing.

The SNS information acquisition unit 121 acquires the SNS information relating to the first target account and the second target account from the first SNS management apparatus 101a and the second SNS management apparatus 101b, respectively (step S101).

For example, the SNS information acquisition unit 121 acquires the first SNS information relating to the first target account (in other words, the first SNS information associated with the user ID of the first target account) from the first SNS management apparatus 101a. Further, for example, the SNS information acquisition unit 121 acquires the second SNS information relating to the second target account (in other words, the second SNS information associated with the user ID of the second target account) from the second SNS management apparatus 101b.

Herein, the SNS information acquisition unit 121 may acquire at least the association information and the transmission/reception information associated with the user ID of each of the first target account and the second target account.

The determination unit 122 determines the first acquaintance account group and the second acquaintance account group by using the SNS information being acquired in step S101 (step S102).

For example, the determination unit 122 determines the first acquaintance account group satisfying the predetermined relationship from the first associated account group being associated based on the association information included in the first SNS information.

Specifically, for example, the determination unit 122 refers to transmission/reception information relating to one or a plurality of first associated accounts constituting the first associated account group, and determines an account with one or a plurality of user IDs associated with the transmission/reception information including a conversation, as the first acquaintance account. With this, the determination unit 122 determines the first acquaintance account group consisting of the one or plurality of first acquaintance accounts.

Further, for example, the determination unit 122 determines the second acquaintance account group satisfying the predetermined relationship from the second associated account group being associated based on the association information included in the second SNS information.

Specifically, for example, the determination unit 122 refers to transmission/reception information relating to one or a plurality of second associated accounts constituting the second associated account group, and determines an account with one or a plurality of user IDs associated with the transmission/reception information including a conversation, as the second acquaintance account. With this, the determination unit 122 determines the second acquaintance account group consisting of the one or plurality of second acquaintance accounts.

The SNS information acquisition unit 121 acquires the SNS information relating to the first acquaintance account group and the second acquaintance account group that are determined in step S102, from the first SNS management apparatus 101a and the second SNS management apparatus 101b, respectively (step S103).

For example, the SNS information acquisition unit 121 acquires the first SNS information relating to the first acquaintance account group (in other words, the first SNS information associated with the user ID of each of the one or plurality of first acquaintance accounts) from the first SNS management apparatus 101a. Further, for example, the SNS information acquisition unit 121 acquires the second SNS information relating to the second acquaintance account group (in other words, the second SNS information associated with the user ID of each of the one or plurality of second acquaintance accounts) from the second SNS management apparatus 101b.

The decision unit 123 decides identity of a person using the first target account and the second target account, based on the similarity between the first person group and the second person group (step S104). The first person group and the second person group herein are person groups that use the first acquaintance account group and the second acquaintance account group that are determined in step S102, respectively.

For example, the decision unit 123 acquires the first likelihood for each combination of the first acquaintance account and the second acquaintance account that are included in the first acquaintance account group and the second acquaintance account group, respectively, by using the SNS information being acquired in step S103. Further, the decision unit 123 computes the acquaintance similarity degree by using the first likelihood. The decision unit 123 decides target person identity of the first target account and the second target account, by using the acquaintance similarity degree.

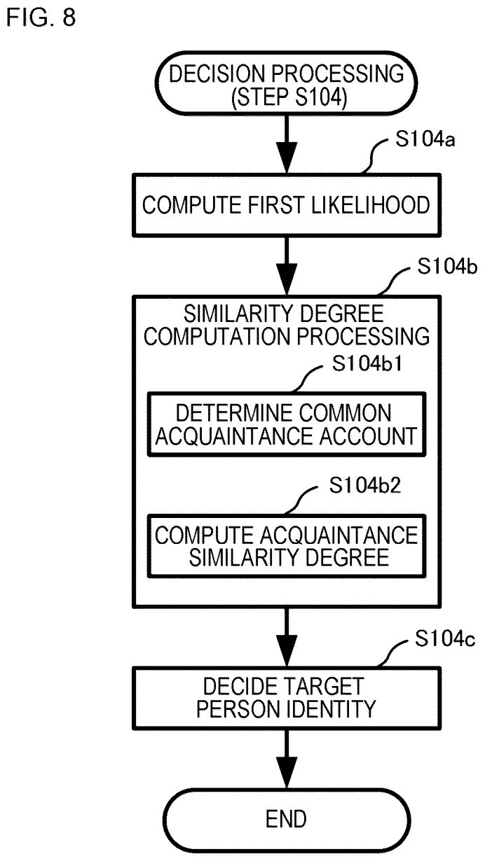

FIG. 8 is a flowchart illustrating one example of decision processing (step S104).

The first likelihood computation unit 124 computes the first likelihood for each combination of the first acquaintance account and the second acquaintance account that are included in the first acquaintance account group and the second acquaintance account group that are determined in step S102, respectively (step S104a).

For example, the first likelihood computation unit 124 computes the first likelihood by using the SNS information being acquired in step S103. In general, the SNS information relating to accounts used by the same person is more likely to exhibit a high degree of similarity. Thus, for each combination of the first acquaintance account and the second acquaintance account, the first likelihood computation unit 124 computes, as the first likelihood, a degree of similarity (similarity degree) of the SNS information between the first acquaintance account and the second acquaintance account.

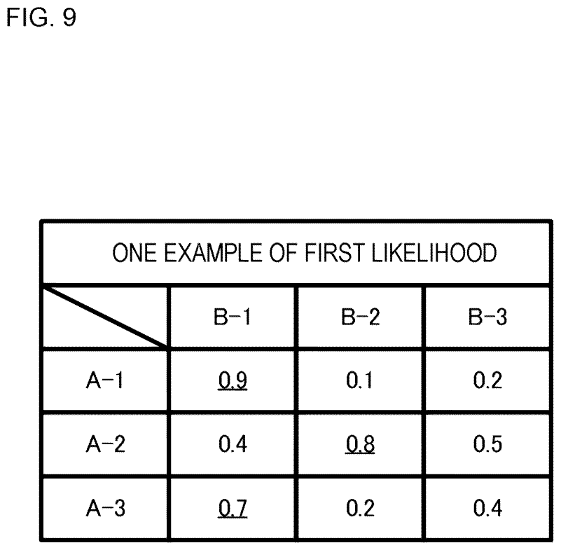

FIG. 9 is a diagram illustrating one example of the first likelihood computed for each combination of first acquaintance accounts A-1 to A-3 and second acquaintance accounts B-1 to B-3. Each of the first likelihoods illustrated in the drawing is associated with the similarity degree of the SNS information for each combination of the first acquaintance accounts A-1 to A-3 and the second acquaintance accounts B-1 to B-3.

A general method may be used as a method of computing the similarity degree of the SNS information. For example, the similarity degree of the SNS information is a value being at least one of a similarity degree of a sentence and a similarity degree of an image that are included in the SNS information, or a value acquired by integrating those similarity degrees (for example, a simple average value, an average value acquired by weighting with a data volume of the sentence and the image).

Note that, a method of computing the first likelihood is not limited thereto.

The similarity degree computation unit 125 computes the acquaintance similarity degree by using the first likelihood being acquired in step S104a (step S104b).

Specifically, for example, the common acquaintance determination unit 125a determines the common acquaintance account being a combination of the first acquaintance account and the second acquaintance account that are used by the same person, by using the first likelihood (step S104b1).

For example, the common acquaintance determination unit 125a narrows down the combination of the first acquaintance account and the second acquaintance account by using a likelihood threshold value being set in advance. For example, when the first likelihood illustrated in FIG. 9 is computed, and the likelihood threshold value is 0.5, the common acquaintance determination unit 125a determines the combination of the first acquaintance account and the second acquaintance account with the first likelihood of equal to or greater than 0.5. In the example in FIG. 9, the common acquaintance determination unit 125a determines the combinations associated with the first likelihood indicated with an underline (in other words, the combination of A-1 and B-1, the combination of A-3 and B-1, and the combination of A-2 and B-2).

The common acquaintance determination unit 125a determines the common acquaintance account among the combinations of the first acquaintance account and the second acquaintance account that are narrowed down. In this state, for example, the common acquaintance determination unit 125a may determine the common acquaintance account in such a way that any of the first acquaintance account and the second acquaintance account are different from those of the common acquaintance accounts.

Specifically, for example, the common acquaintance determination unit 125a determines the combination of the first acquaintance account and the second acquaintance account as the common acquaintance account in order of highest first likelihood while excluding the first acquaintance account and the second acquaintance account that are previously determined as the common acquaintance account.

In the example in FIG. 9, the common acquaintance determination unit 125a determines the combination of A-1 and B-1 with the first likelihood of 0.9, as the common acquaintance account. Subsequently, the common acquaintance determination unit 125a determines the combination of A-2 and B-2 with the first likelihood of 0.8, as the common acquaintance account. The next combination with a higher first likelihood is the combination of A-3 and B-1 with the first likelihood of 0.7. However, B-1 in the combination with A-1 is previously determined as the common acquaintance account. Thus, the common acquaintance determination unit 125a does not determine the combination of A-3 and B-1 as the common acquaintance account.

As a result of such processing, in the example in FIG. 9, the common acquaintance determination unit 125a determines each of the combination of A-1 and B-1 and the combination of A-2 and B-2 as the common acquaintance account.

The acquaintance similarity degree computation unit 125b computes the acquaintance similarity degree by using the first likelihood being computed for the common acquaintance account being determined in step S104b1 (step S104b2).

For example, the acquaintance similarity degree computation unit 125b computes a value acquired by dividing a total value of the first likelihoods being computed for the common acquaintance accounts by a smaller value of the number of first acquaintance accounts and the number of second acquaintance accounts, as the acquaintance similarity degree.

In the example in FIG. 9, the acquaintance similarity degree is 0.57 acquired by dividing the total of the first likelihoods 0.9 and 0.8 associated with the combination of A-1 and B-1 and the combination of A-2 and B-2, respectively, which are determined as the common acquaintance accounts, by 3. The numeral “3” herein is associated with the smaller value of the number of first acquaintance accounts and the number of second acquaintance accounts. In the example in FIG. 9, both the numbers are 3, and hence 3 is used as the smaller value.

Note that, a method of computing the acquaintance similarity degree is not limited thereto. For example, the acquaintance similarity degree may be the number of common acquaintance accounts, in other words, the number of combinations of the first acquaintance account and the second acquaintance account that are determined as the common acquaintance accounts.

The identity decision unit 126 decides identity of a person using the first target account and the second target account, based on the acquaintance similarity degree being computed in step S104b2 (step S104c), and terminates the information processing.

For example, the identity decision unit 126 decides the target person identity, based on a result of comparison between the acquaintance similarity degree being computed by the similarity degree computation unit 125 and a similarity degree threshold value being set in advance.

Specifically, for example, when the acquaintance similarity degree is 0.57, and the similarity threshold value is 0.5, the acquaintance similarity degree is equal to or greater than the similarity threshold value, and hence the identity decision unit 126 decides a person using the first target account and the second target account is identical. On the contrary, for example, when the acquaintance similarity degree is less than the similarity threshold value, the identity decision unit 126 decides that a person using the first target account and the second target account is not identical.

The identity decision unit 126 may output a decision result. For example, the identity decision unit 126 may cause a display unit, which is omitted in illustration, to display the decision result. The decision result may include information whether the first target account and the second target account are identical. The decision result may further include the acquaintance similarity degree.

Note that, an output method is not limited thereto.

According to the present example embodiment described above, the information processing apparatus 102 includes the SNS information acquisition unit 121, the determination unit 122, and the decision unit 123.

The determination unit 122 determines a first acquaintance account group and a second acquaintance account group that are associated with a first target account and a second target account, respectively. The decision unit 123 decides identity of a person using the first target account and the second target account, based on similarity between a first person group and a second person group that use the first acquaintance account group and the second acquaintance account group, respectively.

With this, for deciding the identity of the person using the first target account and the second target account, the similarity between the first person group and the second person group that use the first acquaintance account group and the second acquaintance account group, respectively, can be used. In general, as the similarity between the first person group and the second person group is higher, it is more likely that a person using the first target account and the second target account is identical. Therefore, it is possible to accurately decide identity of a person using a plurality of target accounts.

According to the present example embodiment, the determination unit 122 includes the first likelihood computation unit 124, the similarity degree computation unit 125, and the identity decision unit 126.

The first likelihood computation unit 124 computes first likelihood for each combination of a first acquaintance account constituting the first acquaintance account group and a second acquaintance account constituting the second acquaintance account group. The first likelihood indicates likelihood in which a person using the first acquaintance account and the second acquaintance account is identical.

The similarity degree computation unit 125 computes an acquaintance similarity degree being a value indicating similarity between the first person group and the second person group, by using the first likelihood being acquired.

The identity decision unit 126 decides identity of a person using the first target account and the second target account, based on the acquaintance similarity degree.

With this, the identity of a person using the first target account and the second target account can be decided by using the similarity between the first person group and the second person group that use the first acquaintance account group and the second acquaintance account group, respectively.

Therefore, it is possible to accurately decide identity of a person using a plurality of target accounts.

According to the present example embodiment, the similarity degree computation unit 125 includes the common acquaintance determination unit 125a and the acquaintance similarity degree computation unit 125b.

The common acquaintance determination unit 125a determines a common acquaintance account being a combination of the first acquaintance account and the second acquaintance account that are used by the same person, by using the first likelihood. The acquaintance similarity degree computation unit 125b computes the acquaintance similarity degree by using the first likelihood being computed for the common acquaintance account being determined.

With this, the identity of a person using the first target account and the second target account can be decided by using the similarity between the first person group and the second person group that use the first acquaintance account group and the second acquaintance account group, respectively. Therefore, it is possible to accurately decide identity of a person using a plurality of target accounts can be decided accurately.

According to the present example embodiment, the common acquaintance account is determined in such a way that both the first acquaintance account and the second acquaintance account are different from those of another common acquaintance account.

By determining the common acquaintance account described above, overall similarity between the first person group and the second person group that use the first acquaintance account group and the second acquaintance account group, respectively, can be decided. Therefore, it is possible to accurately decide identity of a person using a plurality of target accounts.

According to the present example embodiment, the first likelihood is computed based on the similarity of SNS information associated with the first acquaintance account and the second acquaintance account.

In general, when the same person uses the first acquaintance account and the second acquaintance account, the SNS information relating thereto is more likely to exhibit a high degree of similarity. Thus, likelihood that a person using the first acquaintance account and the second acquaintance account is identical can be computed appropriately, based on the similarity of the SNS information. Therefore, it is possible to accurately decide identity of a person using a plurality of target accounts.

### Second Example Embodiment

In the present example embodiment, description is made on an example in which, when there are a plurality of acquaintance accounts used by the same person in one SNS, the plurality of acquaintance accounts are integrated into one acquaintance account.

In the present example embodiment, for simplification of the description, a different point from the first example embodiment is mainly described, and a matter similar to that in the first example embodiment is omitted in description as appropriate.

For example, an information processing apparatus according to the present example embodiment functionally includes a determination unit 222 in place of the determination unit 122 according to the first example embodiment. Except for this, for example, the information processing apparatus according to the present example embodiment may functionally include constituent elements similar to those of the information processing apparatus 100 according to the first example embodiment.

Similarly to the determination unit 122 according to the first example embodiment, the determination unit 222 determines a first acquaintance account group and a second acquaintance account group that are associated with a first target account and a second target account, respectively. The determination unit 222 uses an integrated account acquired by integrating accounts used by the same person for each of the first acquaintance account and the second acquaintance account.

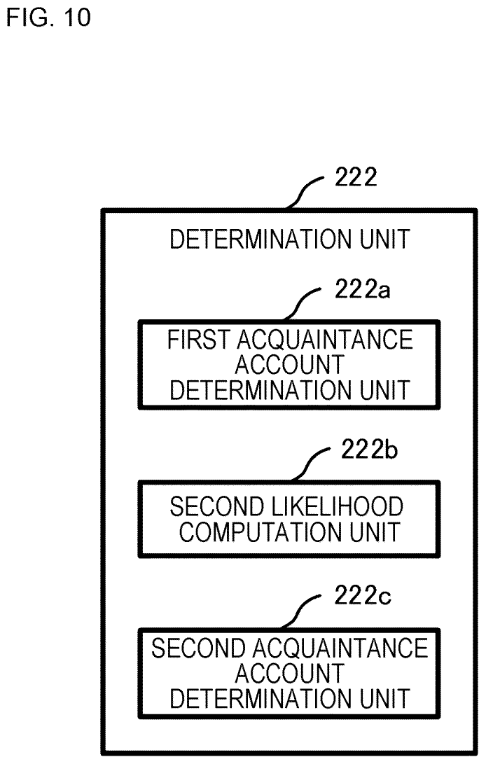

FIG. 10 is a diagram illustrating a functional configuration example of the determination unit 222. The determination unit 222 includes a first acquaintance account determination unit 222a, a second likelihood computation unit 222b, and a second acquaintance account determination unit 222c.

Similarly to the determination unit 122 according to the first example embodiment, the first acquaintance account determination unit 222a determines an acquaintance account group being associated with a target account.

For example, similarly to the determination unit 122 according to the first example embodiment, the first acquaintance account determination unit 222a determines the first acquaintance account group and the second acquaintance account group that are associate with the first target account and the second target account, respectively.

The second likelihood computation unit 222b computes second likelihood indicating likelihood in which a person using accounts is identical, for each of the acquaintance account groups being determined by the first acquaintance account determination unit 222a.

For example, the second likelihood computation unit 222b computes the second likelihood indicating likelihood that a person using the first acquaintance account group being determined by the first acquaintance account determination unit 222a is identical. Further, for example, the second likelihood computation unit 222b computes the second likelihood indicating likelihood that a person using the second acquaintance account group being determined by the first acquaintance account determination unit 222a is identical.

The second acquaintance account determination unit 222c determines the acquaintance account group from the acquaintance account groups being determined by the first acquaintance account determination unit 222a by generating the integrated account acquired by integrating associated accounts used by the same person by using the second likelihood.

For example, the second acquaintance account determination unit 222c determines a combination of the first acquaintance accounts in such a way that the second likelihood being computed for the first acquaintance account group satisfies a predetermined condition, and generates the integrated account acquired by integrating the combination of the first acquaintance accounts. Further, the second acquaintance account determination unit 222c determines the first acquaintance account group consisting of the integrated account being generated and the first acquaintance account not being determined as the integrated account.

For example, the second acquaintance account determination unit 222c determines a combination of the second acquaintance accounts in such a way that the second likelihood being computed for the second acquaintance account group satisfies a predetermined condition, and generates the integrated account acquired by integrating the combination of the second acquaintance accounts. Further, the second acquaintance account determination unit 222c determines the second acquaintance account group consisting of the integrated account being generated and the second acquaintance account not being determined as the integrated account.

### (Operation Example of Information Processing System)

Information processing according to the present example embodiment is described with reference to FIG. 7.

Step S101 similar to that in the first example embodiment is executed.

Subsequently, determination processing (step S202) according to the present example embodiment is executed in place of the determination processing (step S102) according to the first example embodiment. In step S202, a point that the determination unit 222 determines the first acquaintance account group and the second acquaintance account group by using SNS information being acquired in step S101 is similar to step S102 according to the first example embodiment.

In step S202, a point that, when there are accounts used by the same person in each of the first acquaintance account group and the second acquaintance account group, the integrated account acquired by integrating the accounts is used is different from step S102 according to the first example embodiment.

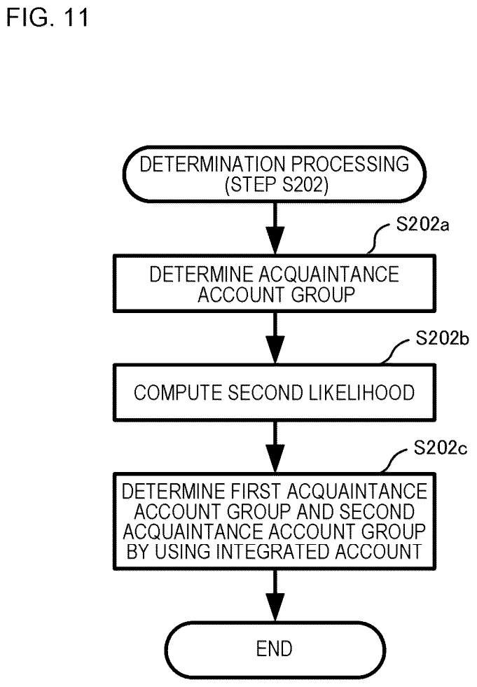

FIG. 11 is a flowchart illustrating another example of the determination processing (step S202).

Similarly to the determination processing (step S102) according to the first example embodiment, the first acquaintance account determination unit 222a determines the first acquaintance account group and the second acquaintance account group by using the SNS information being acquired in step S101 (step S202a).

The second likelihood computation unit 222b computes the second likelihood for each of the first acquaintance account group and the second acquaintance account group that are determined in step S202a (step S202b).

For example, the second likelihood computation unit 222b computes the second likelihood for each combination of the first acquaintance accounts constituting the first acquaintance account group, by using the SNS information being acquired in step S101. Further, for example, the second likelihood computation unit 222b computes the second likelihood for each combination of the second acquaintance accounts constituting the second acquaintance account group, by using the SNS information being acquired in step S101.

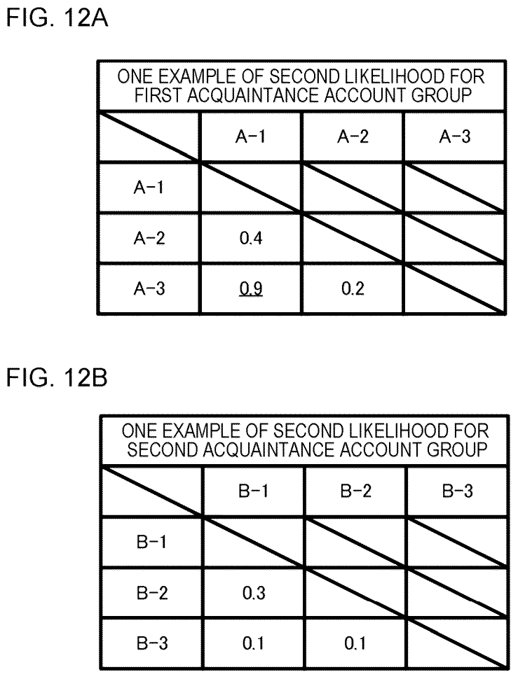

FIG. 12A and FIG. 12B are a diagram illustrating one example of the second likelihood. FIG. 12A is a diagram illustrating one example of the second likelihood for the first acquaintance account group (in other words, each combination of the first acquaintance accounts). FIG. 12B is a diagram illustrating one example of the second likelihood for the second acquaintance account group (in other words, each combination of the second acquaintance accounts).

A method of computing the second likelihood from the SNS information may be similar to the method of computing the first likelihood from the SNS information in the first example embodiment.

When the integrated account is generated by using the second likelihood, the second acquaintance account determination unit 222c determines the acquaintance account group consisting of the integrated account and the acquaintance account not being determined as the integrated account (step S202c).

For example, when there is a combination with the second likelihood being computed for the first acquaintance account group, which is equal to or greater than a reference value being set in advance, the second acquaintance account determination unit 222c generates the integrated account acquired by integrating the combination of the first acquaintance accounts. Further, the second acquaintance account determination unit 222c determines the integrated account and the first acquaintance account not being determined as the integrated account as the first acquaintance account group.

For example, when there is a combination with the second likelihood being computed for the second acquaintance account group, which is equal to or greater than a reference value being set in advance, the second acquaintance account determination unit 222c generates the integrated account acquired by integrating the combination of the second acquaintance accounts. Further, the second acquaintance account determination unit 222c determines the integrated account and the second acquaintance account not being determined as the integrated account as the second acquaintance account group.

Specifically, for example, when the second likelihood illustrated in FIGS. 12A and 12B is computed in step S202b, and the reference value is 0.6, the second acquaintance account determination unit 222c generates an integrated account SA-1 acquired by integrating the combination of A-1 and A-3. In this case, the second acquaintance account determination unit 222c determines SA-1 acquired by integrating A-1 and A-3, and A-2 as the first acquaintance account group. Further, for the second acquaintance account group, the integrated account is not generated, and hence the second acquaintance account determination unit 222c determines B-1, B-2, and B-3 as the second acquaintance account group.

Subsequently, an SNS information acquisition unit 121 acquires the SNS information relating to the first acquaintance account group and the second acquaintance account group that are determined in step S202a, from a first SNS management apparatus 101a and a second SNS management apparatus 101b, respectively (step S103).

In other words, with regard to the integrated account SA-1, the SNS information relating to each of the acquaintance accounts A-1 and A-3 that constitute the integrated account SA-1 is acquired.

When the integrated account is generated, a decision unit 123 decides identity of a person using the plurality of target accounts, based on similarity of a person group using the acquaintance account group including the integrated account (step S104).

When the integrated account is not generated, the decision unit 123 may execute step S104 similar to that in the first example embodiment. Thus, hereinafter, description is made on an example of step S104 when the integrated account is generated. Note that, description is made while giving an example in which the integrated account is included in the first acquaintance account group being determined, and the integrated account may be included at least one of the first acquaintance account group and the second acquaintance account group being determined.

Similarly to the first example embodiment, a first likelihood computation unit 124 computes first likelihood for each combination of the first acquaintance account and the second acquaintance account that are included in the first acquaintance account group and the second acquaintance account group being determined in step S102, respectively (step S104a).

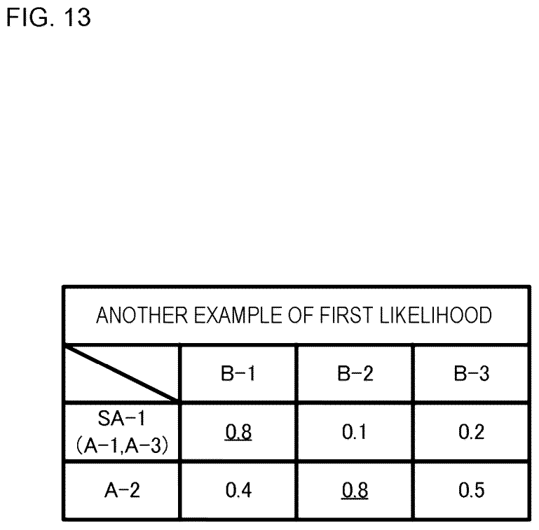

FIG. 13 is a diagram illustrating another example of the first likelihood being computed for each combination of the first acquaintance accounts SA-1 and A-3, and the second acquaintance accounts B-1 to B-3.

For example, the first likelihood for the combination including the integrated account SA-1 may be computed based on the first likelihood for each of the acquaintance accounts A-1 and A-3 constituting the integrated account SA-1, and each of the other accounts B-1 to B-3. Note that, the first likelihood for the combination not including the integrated account SA-1 may be similar to that in the first example embodiment.

Specifically, for example, the first likelihood for the integrated account SA-1 and the other account B-1 may be a maximum value, an average value, or the like of the first likelihood for each of the acquaintance accounts A-1 and A-3 constituting the integrated account and the other account B-1.

Further, for example, the first likelihood for the combination including the integrated account SA-1 and each of the other accounts B-1 to B-3 may be a degree of similarity between integrated SNS information acquiring by integrating the SNS information relating to the acquaintance accounts A-1 and A-3, and the SNS information relating to each of the other accounts B-1 to B-3.

Specifically, for example, the first likelihood computation unit 124 generates the integrated SNS information acquired by integrating the SNS information relating to the acquaintance accounts A-1 and A-3 constituting the integrated account. For example, the integrated SNS information may be generated by complementing a piece of information being missing in at least one of the acquaintance accounts A-1 and A-3 constituting the integrated account with the other one of the acquaintance accounts A-1 and A-3 constituting the integrated account.

Further, the first likelihood computation unit 124 acquires a degree of similarity between the integrated SNS information being generated and the SNS information relating to each of the other accounts B-1 to B-3. A value being acquired in this manner may be used as the first likelihood for the integrated account SA-1 and each of the other account B-1.

Similarly to the first example embodiment, a similarity degree computation unit 125 computes an acquaintance similarity degree by using the first likelihood being acquired in step S104a (step S104b).

For example, the similarity degree computation unit 125 determines a common acquaintance account in order of highest first likelihood from the combinations of the first acquaintance account and the second acquaintance account that have the first likelihoods equal to or greater than a likelihood threshold value (step S104b1).

At a time of determining the common acquaintance account, the similarity degree computation unit 125 may exclude the first acquaintance account and the second acquaintance account that are previously determined as the common acquaintance account. With this, when the first acquaintance account or the second acquaintance account is in a combination with another second acquaintance account or first acquaintance account, it is possible to prevent the first acquaintance account or the second acquaintance account being previously determined as the common acquaintance account from being determined as the common acquaintance account again.

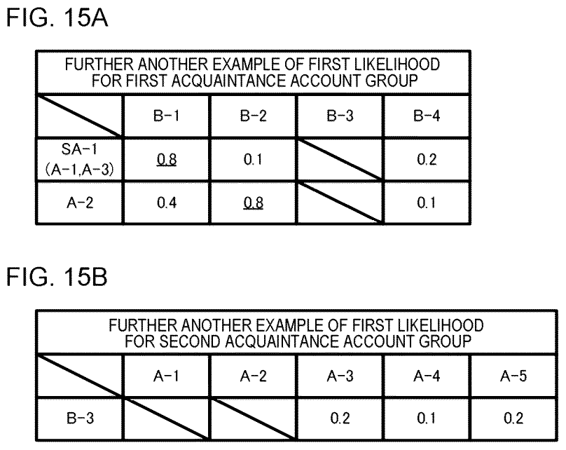

Specifically, for example, when the first likelihood illustrated in FIGS. 15A and 15B is computed, and the likelihood threshold value is 0.5, a common acquaintance determination unit 125a determines the combination of the first acquaintance account and the second acquaintance account with the first likelihood of equal to or greater than 0.5. In the example in FIGS. 15A and 15B, the common acquaintance determination unit 125a determines the combinations associated with the first likelihood indicated with an underline (in other words, the combination of SA-1 and B-1, and the combination of A-2 and B-2).

Further, the common acquaintance determination unit 125a determines the combination of the first acquaintance account and the second acquaintance account as the common acquaintance account in order of highest first likelihood while excluding the first acquaintance account and the second acquaintance account that are previously determined as the common acquaintance account.

In the example in FIG. 13, by executing the processing in step S104b1, the common acquaintance determination unit 125a determines each of the combination of SA-1 and B-1 and the combination of A-2 and B-2 as the common acquaintance account.

An acquaintance similarity degree computation unit 125b computes the acquaintance similarity degree by using the first likelihood being computed for the common acquaintance account being determined in step S104b1 (step S104b2).

In the example in FIG. 13, the acquaintance similarity degree is 0.8 acquired by dividing a total of the first likelihoods 0.8 and 0.8 associated with the combination of SA-1 and B-1 and the combination of A-2 and B-2, respectively, which are determined as the common acquaintance accounts, by 2. The numeral “2” herein is associated with a smaller value of the number of first acquaintance accounts and the number of second acquaintance accounts. In the example in FIG. 13, because the number of first acquaintance accounts is 2, and the number of second acquaintance accounts is 3, 2 in the former case is used. In other words, the integrated account is handled as one account.

Similarly to the first example embodiment, an identity decision unit 126 decides identity of a person using the first target account and the second target account, based on the acquaintance similarity degree being computed in step S104b2 (step S104c), and terminates the information processing.

According to the present example embodiment described above, for each of the first acquaintance account and the second acquaintance account, the accounts used by the same person are integrated.

With this, for deciding identity of a person using the first target account and the second target account, more appropriate similarity between the first person group and the second person group that use the first acquaintance account group and the second acquaintance account group, respectively, can be used. Therefore, it is possible to accurately decide identity of a person using a plurality of target accounts.

### Third Example Embodiment

In the present example embodiment, description is made on an example in which relationship information is used at a time of computing first likelihood. When target accounts commonly share an acquaintance account whose relationship indicated by the relationship information is an extremely close or intimate predetermined relationship, for example, such as a parent, a romantic partner, and a family member, it is more likely that the target accounts are used by the same person.

Thus, in the present example embodiment, description is made on an example in which the first likelihood is computed for each of a first acquaintance account group and a second acquaintance account group whose first relationship information and second relationship information indicate predetermined relationships, and each combination of a second associated account group and a first associated account group.

In the present example embodiment, for simplification of the description, a different point from the above-mentioned example embodiments is mainly described, and a matter similar to that in the above-mentioned example embodiments is omitted in description as appropriate.

For example, an information processing apparatus according to the present example embodiment may functionally include constituent elements similar to those of the information processing apparatus according to the second example embodiment.

### (Operation Example of Information Processing System)

Information processing according to the present example embodiment is described with reference to FIG. 7.

Step S101 similar to that in the first example embodiment is executed.

In determination processing (step S202) according to the present example embodiment, similarly to step S102 according to the first example embodiment, the first acquaintance account group and the second acquaintance account group that are associated with the first target account and the second target account, respectively, are determined.

In step S202 according to the present example embodiment, when there are accounts used by the same person in the first acquaintance account group and a second associated account group, an integrated account acquired by integrating those accounts is used. Further, when there are accounts used by the same person in the second acquaintance account group and a first associated account group, the integrated account acquired by integrating those accounts is used.

Details of the determination processing (step S202) according to the present example embodiment described above are described with reference to FIG. 11.

Similarly to the determination processing (step S102) according to the first example embodiment, a first acquaintance account determination unit 222a determines the first acquaintance account group and the second acquaintance account group by using SNS information being acquired in step S101 (step S202a).

For example, the first acquaintance account determination unit 222a determines the associated account whose relationship information satisfies a predetermined relationship, as the acquaintance account. The predetermined relationship in the present example embodiment may be set as appropriate, and is preferably an extremely close relationship such as a parent, a romantic partner, and a family member.

A second likelihood computation unit 222b computes second likelihood for each of the first acquaintance account group and the second acquaintance account group that are determined in step S202a, and the first associated account group and the second associated account group (step S202b).

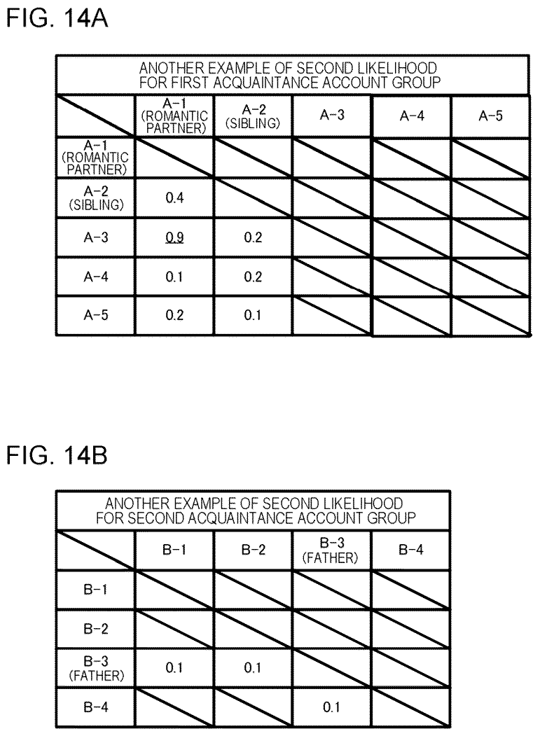

FIG. 14A and FIG. 14B are a diagram illustrating another example of the second likelihood. FIG. 14A is a diagram illustrating one example of the second likelihood for each of the first acquaintance accounts and a first associated account. FIG. 14B is a diagram illustrating one example of the second likelihood for each of the second acquaintance accounts in the second acquaintance account group that are associated with the second relationship information indicating the predetermined relationship and the first associated account.

Herein, the first relationship information is relationship information included in the first target account, and indicates a relationship with the first acquaintance account. The second relationship information is relationship information included in the second target account, and indicates a relationship with the second acquaintance account.

In the example in FIGS. 14A and 14B, it is assumed that, among first associated accounts A-1 to A-5, the first associated accounts that satisfy the predetermined relationship are A-1 and A-2. Further, it is assumed that, among second associated accounts B-1 to B-4, the second associated account that satisfies the predetermined relationship is B-3.

When the integrated account is generated by using the second likelihood, a second acquaintance account determination unit 222c determines an acquaintance account group consisting of the integrated account and the acquaintance account not being determined as the integrated account (step S202c).

When the second likelihood illustrated in FIGS. 14A and 14B is computed in step S202b, and a reference value is 0.6, the second acquaintance account determination unit 222c generates an integrated account SA-1 acquired by integrating the combination of A-1 and A-3. In this case, the second acquaintance account determination unit 222c determines SA-1 acquired by integrating A-1 and A-3, and A-2 as the first acquaintance account group. Further, for the second acquaintance account group, the integrated account is not generated, and hence the second acquaintance account determination unit 222c determines B-3 as the second acquaintance account group.

Subsequently, similarly to the second example embodiment, an SNS information acquisition unit 121 acquires SNS information relating to the first acquaintance account group and the second acquaintance account group that are determined in step S202a (step S103).

When the integrated account is generated, a decision unit 123 decides identity of a person using the plurality of target accounts, based on similarity of a person group using the acquaintance account group (step S104). Herein, when the integrated account is generated, the acquaintance account group may include the integrated account. The integrated account in this case may be included in at least one of the first acquaintance account group and the second acquaintance account group being determined.

Hereinafter, with reference to FIG. 8, description is made on a detailed example of step S104 when the integrated account is generated.

A first likelihood computation unit 124 computes first likelihood for each combination of one acquaintance account and the other second associated account that are determined in step S102 (step S104a).

For example, the first likelihood computation unit 124 computes the first likelihood for each combination of the first acquaintance account included in the first acquaintance account group being determined in step S102 and the second associated account included in the second associated account group. Further, for example, the first likelihood computation unit 124 computes the first likelihood for each combination of the second acquaintance account included in the second acquaintance account group being determined in step S102 and the first associated account included in the first associated account group.

FIG. 15A and FIG. 15B are a diagram illustrating another example of the first likelihood. FIG. 15A is a diagram illustrating one example of the first likelihood being computed for each combination of the first acquaintance accounts SA-1 and A-2 and the second acquaintance accounts B-1 to B-4. FIG. 15B is a diagram illustrating one example of the first likelihood being computed for each combination of the second acquaintance account B-3 and the first acquaintance accounts A-1 to A-5.

Herein, a combination of an acquaintance account whose relationship with the target account is different and the associated account is less likely to be used by the same person, and hence may be excluded at a time of computing the first likelihood. Thus, in FIGS. 15A and 15B, the first likelihood for a combination of each of the first acquaintance accounts SA-1 and A-2 and the second acquaintance account B-3, and the first likelihood for a combination of each of the first acquaintance accounts A-1 and A-2 and the second acquaintance account B-3 are not computed.

It can also be said that the first likelihood in this case indicates likelihood that a first person group and a second person group are identical to the person groups that use the second associated account group and the first associated account group, respectively. As described above, the first person group and the second person group are person groups that use the first acquaintance account and the second acquaintance account, respectively.

A similarity degree computation unit 125 computes an acquaintance similarity degree by using the first likelihood being acquired in step S104a (step S104b).

For example, similarly to the first example embodiment, the similarity degree computation unit 125 determines a common acquaintance account (step S104b1).

In the example in FIGS. 15A and 15B, by executing the processing in step S104b1, a common acquaintance determination unit 125a determines each of the combination of SA-1 and B-1 and the combination of A-2 and B-2 as the common acquaintance account.

An acquaintance similarity degree computation unit 125b computes the acquaintance similarity degree by using the first likelihood being computed for the common acquaintance account being determined in step S104b1 (step S104b2).

In the example in FIGS. 15A and 15B, the acquaintance similarity degree is 0.53 acquired by dividing a total of the first likelihoods 0.8 and 0.8 associated with the combination of SA-1 and B-1 and the combination of A-2 and B-2, respectively, which are determined as the common acquaintance accounts, by 3. The numeral “3” herein is the number of acquaintance accounts that satisfy a predetermined relationship.

For example, when the acquaintance accounts that satisfy the predetermined relationship include a plurality of acquaintance accounts with the same relationship, the plurality of acquaintance accounts may be handled as one account. For example, in the example in FIGS. 15A and 15B, when the relationship of the acquaintance account B-3 is not a father but a romantic partner, the relationships between the acquaintance B-3 and the acquaintance account A-1 are the same. In the example in FIGS. 15A and 15B, which is thus modified, the number of acquaintance accounts that satisfy the predetermined relationship becomes 2.

Similarly to the first example embodiment, an identity decision unit 126 decides identity of a person using the first target account and the second target account, based on the acquaintance similarity degree being computed in step S104b2 (step S104c), and terminates the information processing.

According to the present example embodiment described above, the first likelihood is computed for each of the combinations including the combination of the first associated account and the second acquaintance account and the combination of the second associated account and the first acquaintance account.

The first associated account is an account associated with the first target account. The first acquaintance account is an account of the first associated accounts that satisfies the predetermined relationship. The second associated account is an account associated with the second target account. The second acquaintance account is an account of the second associated accounts that satisfies the predetermined relationship.

With this, it is possible to acquire the acquaintance similarity degree indicating a degree at which an acquaintance account used by a person satisfying the predetermined relationship is associated commonly with the first target account and the second target account. In general, when the degree at which an acquaintance account used by a person satisfying the predetermined relationship is associated commonly with the first target account and the second target account is higher, it is more likely that a person using the first target account and the second target account is identical. Therefore, it is possible to accurately decide identity of a person using a plurality of target accounts.

### Fourth Example Embodiment

In the first and second example embodiments, description is made on an example in which first likelihood is computed for a combination of acquaintance accounts constituting an acquaintance account group.

However, when one acquaintance account is associated with another acquaintance account in information relating to another SNS account, which indicates a combination of the acquaintance accounts, a first likelihood computation unit 124 may set a predetermined value. Further, an acquaintance account is not associated in the information relating to another SNS account, which indicates a combination of the acquaintance accounts, the first likelihood may be computed.

For example, when the first likelihood is a greater value as likelihood that a person using acquaintance accounts is identical is higher, the predetermined value in this case may be a maximum value of values that the first likelihood may take. Note that, the predetermined value is not limited thereto.

Note that, a method in which any of the predetermined value and a computation value is used as the first likelihood while referring to the information relating to another SNS account as described above is applicable to any of the first to third example embodiments. In the third example embodiment, when an acquaintance account and an associated account are associated with each other in the information relating to another SNS account, the predetermined value may be set to the first likelihood for the combination of the acquaintance account and the associated account.

According to the present example embodiment described above, when a first acquaintance account and a second acquaintance account are associated with each other as accounts used by the same person, the predetermined value is set to the first likelihood.

With this, the first likelihood can be set more accurately by using the SNS information. Therefore, it is possible to accurately decide identity of a person using a plurality of target accounts.

While the example embodiments and the modification examples of the present invention are described above with reference to the drawings, these are merely examples of the present invention, and various modifications other than the matters described above may be adopted.

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments and the modification examples described above may be combined with each other within a range where the contents do not conflict with each other.

The whole or a part of the example embodiments described above can be described as, but not limited to, the following supplementary notes.
1. An information processing apparatus, including:
   a determination unit that determines a first acquaintance account group and a second acquaintance account group being associated with a first target account and a second target account, respectively; and
   a decision unit that decides identity of a person using the first target account and the second target account, based on similarity between a first person group and a second person group using the first acquaintance account group and the second acquaintance account group, respectively.
2. The information processing apparatus according to supplementary note 1, wherein
   the decision unit includes
      a first likelihood computation unit that computes a first likelihood indicating likelihood that a person using a first acquaintance account and a second acquaintance account is identical for each combination of the first acquaintance account constituting the first acquaintance account group and the second acquaintance account constituting the second acquaintance account group,
      a similarity degree computation unit that computes an acquaintance similarity degree being a value indicating similarity between the first person group and the second person group by using the first likelihood being computed, and
      an identity decision unit that decides identity of a person using the first target account and the second target account, based on the acquaintance similarity degree.
3. The information processing apparatus according to supplementary note 2, wherein
   the similarity degree computation unit includes
      a common acquaintance determination unit that determines a common acquaintance account being a combination of the first acquaintance account and the second acquaintance account being used by a same person, by using the first likelihood, and
      an acquaintance similarity degree computation unit that computes the acquaintance similarity degree by using the first likelihood being computed for the common acquaintance account being determined.
4. The information processing apparatus according to supplementary note 3, wherein
   the common acquaintance account is determined in such a way that any of the first acquaintance account and the second acquaintance account are different from those of another common acquaintance account.
5. The information processing apparatus according to any one of supplementary notes 2 to 4, wherein
   the first likelihood is computed based on similarity of SNS information being associated with the first acquaintance account and the second acquaintance account.
6. The information processing apparatus according to any one of supplementary notes 2 to 5, wherein
   accounts being used by a same person in the first acquaintance account and the second acquaintance account are integrated.
7. The information processing apparatus according to any one of supplementary notes 2 to 6, wherein
   the first likelihood is computed for each of combinations including a combination of a first associated account being associated with the first target account and the second acquaintance account satisfying a predetermined relationship among second associated accounts being associated with the second target account, and a combination of the second associated account and the first acquaintance account satisfying the predetermined relationships among the first associated accounts.
8. The information processing apparatus according to any one of supplementary notes 2 to 7, wherein,
   when the first acquaintance account and the second acquaintance account are associated with each other as accounts being used by a same person, a predetermined value is set to the first likelihood.
9. The information processing apparatus according to any one of supplementary notes 1 to 8, wherein
   the first acquaintance account and the second acquaintance account are accounts that transmit and receive information with the first target account and the second target account, respectively.
10. An information processing system, including:
   one or a plurality of SNS management apparatuses that each manages SNS information; and
   the information processing apparatus according to any one of supplementary notes 1 to 9, wherein
   the first target account and the second target account are accounts being managed by the one or plurality of SNS management apparatuses.
11. An information processing method, including,
   by one or more computers:
   determining a first acquaintance account group and a second acquaintance account group being associated with a first target account and a second target account, respectively; and
   deciding identity of a person using the first target account and the second target account, based on similarity between a first person group and a second person group using the first acquaintance account group and the second acquaintance account group, respectively.
12. The information processing method according to supplementary note 11, wherein
   deciding identity of the person includes
      computing first likelihood indicating likelihood that a person using a first acquaintance account and a second acquaintance account is identical for each combination of the first acquaintance account constituting the first acquaintance account group and the second acquaintance account constituting the second acquaintance account group,
      computing an acquaintance similarity degree being a value indicating similarity between the first person group and the second person group by using the first likelihood being computed, and
      deciding identity of a person using the first target account and the second target account, based on the acquaintance similarity degree.
13. The information processing method according to supplementary note 12, wherein
   computing the acquaintance similarity degree includes
      determining a common acquaintance account being a combination of the first acquaintance account and the second acquaintance account being used by a same person, by using the first likelihood, and
      computing the acquaintance similarity degree by using the first likelihood being computed for the common acquaintance account being determined.
14. The information processing method according to supplementary note 13, wherein
   the common acquaintance account is determined in such a way that any of the first acquaintance account and the second acquaintance account are different from those of another common acquaintance account.
15. The information processing method according to any one of supplementary notes 12 to 14, wherein
   the first likelihood is computed based on similarity of SNS information being associated with the first acquaintance account and the second acquaintance account.
16. The information processing method according to any one of supplementary notes 12 to 15, wherein
   accounts being used by a same person in the first acquaintance account and the second acquaintance account are integrated.
17. The information processing method according to any one of supplementary notes 12 to 16, wherein
   the first likelihood is computed for each of combinations including a combination of a first associated account being associated with the first target account and the second acquaintance account satisfying a predetermined relationship among second associated accounts being associated with the second target account, and a combination of the second associated accounts and the first acquaintance account satisfying the predetermined relationships among the first associated accounts.
18. The information processing method according to any one of supplementary notes 12 to 17, wherein,
   when the first acquaintance account and the second acquaintance account are associated with each other as accounts being used by a same person, a predetermined value is set to the first likelihood.
19. The information processing method according to any one of supplementary notes 11 to 18, wherein
   the first acquaintance account and the second acquaintance account are accounts that transmit and receive information with the first target account and the second target account, respectively.
20. A program for causing one or more computers to execute:
   determining a first acquaintance account group and a second acquaintance account group being associated with a first target account and a second target account, respectively; and
   deciding identity of a person using the first target account and the second target account, based on similarity between a first person group and a second person group using the first acquaintance account group and the second acquaintance account group, respectively.
21. The program according to supplementary note 20, wherein
   deciding identity of the person includes
      computing first likelihood indicating likelihood that a person using a first acquaintance account and a second acquaintance account is identical for each combination of the first acquaintance account constituting the first acquaintance account group and the second acquaintance account constituting the second acquaintance account group,
      computing an acquaintance similarity degree being a value indicating similarity between the first person group and the second person group by using the first likelihood being computed, and
      deciding identity of a person using the first target account and the second target account, based on the acquaintance similarity degree.
22. The program according to supplementary note 21, wherein
   computing the acquaintance similarity degree includes
      determining a common acquaintance account being a combination of the first acquaintance account and the second acquaintance account being used by a same person, by using the first likelihood, and
      computing the acquaintance similarity degree by using the first likelihood being computed for the common acquaintance account being determined.
23. The program according to supplementary note 22, wherein
   the common acquaintance account is determined in such a way that any of the first acquaintance account and the second acquaintance account are different from those of another common acquaintance account.
24. The program according to any one of supplementary notes 21 to 23, wherein
   the first likelihood is computed based on similarity of SNS information being associated with the first acquaintance account and the second acquaintance account.
25. The program according to any one of supplementary notes 21 to 24, wherein
   accounts being used by a same person in the first acquaintance account and the second acquaintance account are integrated.
26. The program according to any one of supplementary notes 21 to 25, wherein
   the first likelihood is computed for each of combinations including a combination of a first associated account being associated with the first target account and the second acquaintance account satisfying a predetermined relationship among second associated accounts being associated with the second target account, and a combination of the second associated accounts and the first acquaintance account satisfying the predetermined relationships among the first associated accounts.
27. The program according to any one of supplementary notes 21 to 26, wherein,
   when the first acquaintance account and the second acquaintance account are associated with each other as accounts being used by a same person, a predetermined value is set to the first likelihood.
28. The program according to any one of supplementary notes 20 to 27, wherein
   the first acquaintance account and the second acquaintance account are accounts that transmit and receive information with the first target account and the second target account, respectively.
100 Information processing system
100 Information processing apparatus
101 SNS management apparatus
101a First SNS management apparatus
101b Second SNS management apparatus
102 Information processing apparatus
121 SNS information acquisition unit
122,222 Determination unit
123 Decision unit
124 First likelihood computation unit
125 Similarity degree computation unit
125a Common acquaintance determination unit
125b Acquaintance similarity degree computation unit
126 Identity decision unit
222a First acquaintance account determination unit
222b Second likelihood computation unit
222c Second acquaintance account determination unit

1. An information processing apparatus, comprising:
at least one memory configured to store instructions; and
at least one processor configured to execute the instructions to:
determine a first acquaintance account group and a second acquaintance account group being associated with a first target account and a second target account, respectively; and
decide identity of a person using the first target account and the second target account, based on similarity between a first person group and a second person group using the first acquaintance account group and the second acquaintance account group, respectively.

2. The information processing apparatus according to claim 1, wherein
the deciding the identity of the person includes
computing first likelihood indicating likelihood that a person using a first acquaintance account and a second acquaintance account is identical for each combination of the first acquaintance account constituting the first acquaintance account group and the second acquaintance account constituting the second acquaintance account group,
computing an acquaintance similarity degree being a value indicating similarity between the first person group and the second person group by using the first likelihood being computed, and
deciding identity of a person using the first target account and the second target account, based on the acquaintance similarity degree.

3. The information processing apparatus according to claim 2, wherein
computing an acquaintance similarity degree includes
determining a common acquaintance account being a combination of the first acquaintance account and the second acquaintance account being used by a same person, by using the first likelihood, and
computing the acquaintance similarity degree by using the first likelihood being computed for the common acquaintance account being determined.

4. The information processing apparatus according to claim 3, wherein
the common acquaintance account is determined in such a way that any of the first acquaintance account and the second acquaintance account are different from those of another common acquaintance account.

5. The information processing apparatus according to claim 2, wherein
the first likelihood is computed based on similarity of SNS information being associated with the first acquaintance account and the second acquaintance account.

6. The information processing apparatus according to claim 2, wherein
accounts being used by a same person in the first acquaintance account and the second acquaintance account are integrated.

7. The information processing apparatus according to claim 2, wherein
the first likelihood is computed for each of combinations including a combination of a first associated account being associated with the first target account and the second acquaintance account satisfying a predetermined relationship among second associated accounts being associated with the second target account, and a combination of the second associated account and the first acquaintance account satisfying the predetermined relationships among the first associated accounts.

8. The information processing apparatus according to claim 2, wherein,
when the first acquaintance account and the second acquaintance account are associated with each other as accounts being used by a same person, a predetermined value is set to the first likelihood.

9. An information processing method, comprising,
by one or more computers:
determining a first acquaintance account group and a second acquaintance account group being associated with a first target account and a second target account, respectively; and
deciding identity of a person using the first target account and the second target account, based on similarity between a first person group and a second person group using the first acquaintance account group and the second acquaintance account group, respectively.

10. A non-transitory storage medium storing program for causing one or more computers to execute:
determining a first acquaintance account group and a second acquaintance account group being associated with a first target account and a second target account, respectively; and
deciding identity of a person using the first target account and the second target account, based on similarity between a first person group and a second person group using the first acquaintance account group and the second acquaintance account group, respectively.
